(19) United States
(12) Patent Application Publication
(10) Pub. No.: US 2001/0016949 A1
(43) Pub. Date: Aug. 23, 2001

(54) Channel module apparatus for cable set-top box

(75) Inventor: Jong Jin Lee, Suwon (KR)

Correspondence Address: LOWE HAUPTMAN GOPSTEIN GILMAN & BERNER, LLP, 1700 Diagonal Road, Suite 310, Alexandria, VA, 22314, US

(73) Assignee: SAMSUNG ELECTRO-MECHANICS CO., LTD.

(21) Appl. No.: 09/729,248

(22) Filed: Dec. 5, 2000

(30) Foreign Application Priority Data
Feb. 21, 2000 (KR) 2000-8145
Feb. 24, 2000 (KR) 2000-8992

(51) Int. Cl. H04N 7/16; H04N 7/173

(52) U.S. Cl. 725/111

(57) ABSTRACT

A channel module apparatus for a cable set-top box, comprising a switching block for distributing a signal received via a cable to two or more stages and mixing one of the distributed signals with a radio frequency-modulated signal, a tuner block for tuning to an output signal from the switching block, a channel demodulation block for demodulating an output signal from the tuner block into audio and video signals, and a radio frequency modulation block for modulating the audio and video signals from the channel demodulation block into a television signal. The switching block, radio frequency modulation block, tuner block and channel demodulation block are contained in a single chassis in the form of one package. Further, a first cable connector is provided in the chassis as a connector for a cable modem tuner. Therefore, the number of components and the number of signal line connections can be reduced to improve a matching characteristic and interference characteristic, the price of a product can be lowered to secure the competitiveness of the product and the composite configuration of components can be realized to increase the productivity. Moreover, the cable set-top box can readily be connected to the cable modem tuner, thereby enabling two-way communication.

### BACKGROUND OF THE INVENTION

1. Field of the Invention

The present invention relates in general to channel module apparatus for cable set-top boxes, and more particularly to a channel module apparatus for a cable set-top box, wherein a switching block, radio frequency (RF) modulation block, tuner block and channel demodulation block in the cable set-top box are contained in a single chassis in the form of one package and a first cable connector is provided in the chassis as a connector for a cable modem tuner, so that the number of components and the number of signal line connections can be reduced to improve a matching characteristic and interference characteristic, the price of a product can be lowered to secure the competitiveness of the product and the composite configuration of components can be realized to increase the productivity.

2. Description of the Prior Art

In Europe and other foreign countries, a cable set-top box is generally employed which allows a television to receive a ground-wave broadcast, satellite broadcast, Internet broadcast, etc. via a single cable. This cable set-top box generally comprises a tuner for tuning the set-top box to a desired channel to receive a broadcasting signal of the desired channel through a cable, a channel demodulator for demodulating an output signal from the tuner into audio and video (A/V) signals, and a radio frequency (RF) modulator for mixing the A/V signals from the channel demodulator with an output signal from a VTR, DVD or etc. and transmitting the resulting signal to a television.

With reference to FIG. 1, there is shown in block form an internal construction of a conventional set-top box. As shown in this drawing, the conventional set-top box comprises a tuner 14, channel demodulator 15 and RF modulator 16 as mentioned above, which are made in individual chassis independently of one another. The tuner 14, channel demodulator 15 and RF modulator 16 made in individual chassis are then assembled in a main board of the set-top box. Additionally, the conventional set-top box further comprises a cable modem tuner 17.

FIG. 2 shows transmission and reception frequency bands of the conventional set-top box of FIG. 1, based on, for example, a cable. As shown in this drawing, the reception frequency band is 47 MHz-860 MHz, covering a ground-wave broadcasting signal, satellite broadcasting signal and Internet broadcasting signal. The transmission frequency band is 5 MHz-42 MHz, covering a signal provided from the cable modem tuner.

High-power transmission signals of 5 MHz-42 MHz are blocked by first and second high pass filters (HPFs) 12 and 13 in FIG. 1 such that they have no effect on the tuner 14 and RF modulator 16.

FIG. 3 is a detailed diagram of a switching block in FIG. 1, and FIG. 4 is a view showing the outer appearance of the switching block of FIG. 3. As shown in these drawings, the switching block includes a first amplifier 16a for amplifying a signal received through a cable, and a distributor 16b for distributing an output signal from the first amplifier 16a. One distributed signal from the distributor 16b is supplied to the tuner via a cable output terminal CA-out, and the other distributed signal from the distributor 16b is amplified by a second amplifier 16c, mixed with an output signal from a modulator 16e by a mixer 16d and then supplied to a television via an RF output connector RF-out.

However, the above-stated conventional set-top box is disadvantageous in that the tuner 14, channel demodulator 15 and RF modulator 16 are individually made and contained in independent chassis, resulting in a complexity in inter-component connections and, in turn, a degradation in matching characteristic and interference characteristic. Furthermore, the individual manufacturing of the tuner 14, channel demodulator 15 and RF modulator 16 lowers the productivity, resulting in an increase in production cost.

Moreover, for connection from the cable set-top box to the cable modem tuner, it is required to interrupt the influence by a transmission frequency of a cable modem. To this end, additional high pass filters 12 and 13 as shown in FIG. 1 must be provided, thereby raising the production cost and thus deteriorating the competitiveness of a product.

### SUMMARY OF THE INVENTION

Therefore, the present invention has been made in view of the above problems, and it is an object of the present invention to provide a channel module apparatus for a cable set-top box, wherein a switching block, radio frequency modulation block, tuner block and channel demodulation block in the cable set-top box are contained in a single chassis in the form of one package, so that the number of components and the number of signal line connections can be reduced to improve a matching characteristic and interference characteristic, the price of a product can be lowered to secure the competitiveness of the product and the composite configuration of components can be realized to increase the productivity.

It is another object of the present invention to provide a channel module apparatus for a cable set-top box, wherein a switching block, radio frequency modulation block, tuner block and channel demodulation block in the cable set-top box are contained in a single chassis in the form of one package and a first cable connector is provided in the chassis as a connector for a cable modem tuner, so that the cable set-top box can readily be connected to the cable modem tuner, thereby enabling two-way communication.

In accordance with the present invention, the above and other objects can be accomplished by a provision of a channel module apparatus for a cable set-top box, comprising a switching block for distributing a signal received via a cable to two or more stages and mixing one of the distributed signals with a radio frequency-modulated signal; a tuner block for tuning to an output signal from the switching block; a channel demodulation block for demodulating an output signal from the tuner block into audio and video signals; and a radio frequency modulation block for modulating the audio and video signals from the channel demodulation block into a television signal. Preferably, the switching block, radio frequency modulation block, tuner block and channel demodulation block are contained in a single chassis in the form of one package.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an internal construction of a conventional set-top box;

FIG. 2 is a view showing transmission and reception frequency bands of the conventional set-top box of FIG. 1;

FIG. 3 is a detailed diagram of a switching block in FIG. 1;

FIG. 4 is a view showing the outer appearance of the switching block of FIG. 3;

FIG. 5 is a perspective view showing the outer appearance of a channel module apparatus for a cable set-top box in accordance with the present invention;

FIG. 6 is a block diagram showing an internal construction of the channel module apparatus of FIG. 5; and

FIG. 7 is a detailed diagram of a switching block in FIG. 6.

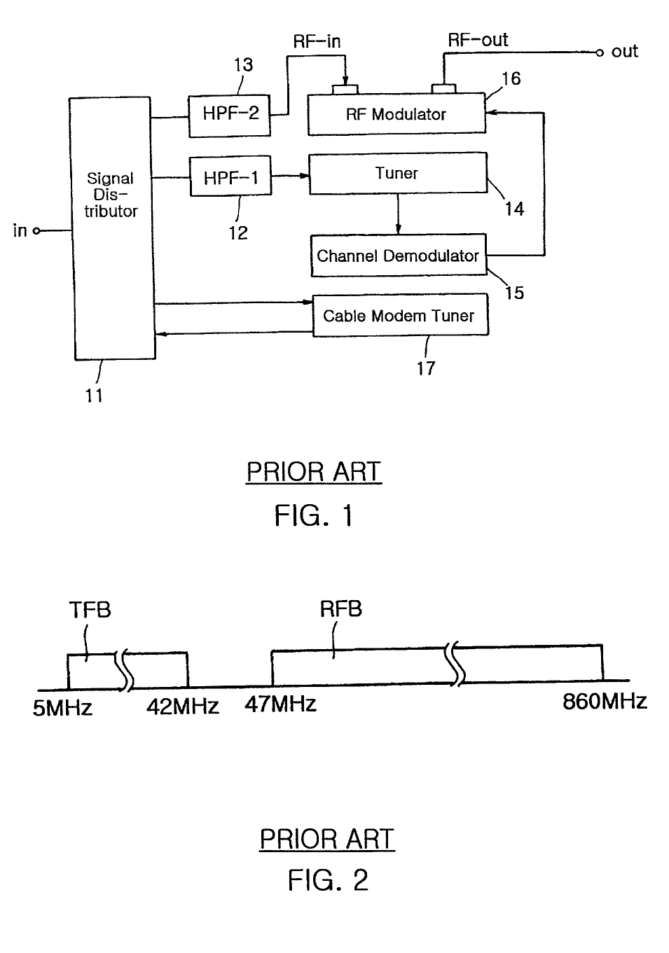

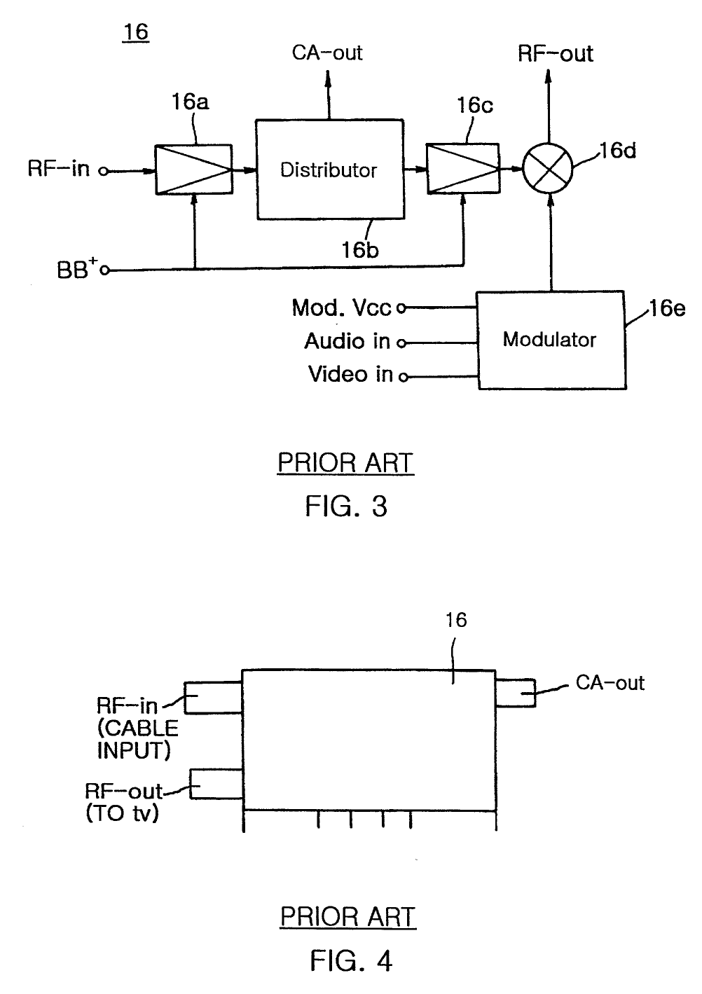

### DETAILED DESCRIPTION OF THE PREFERRED EMBODIMENTS

In the drawings, some parts are substantially the same in construction and operation and they are thus denoted by the same reference numerals.

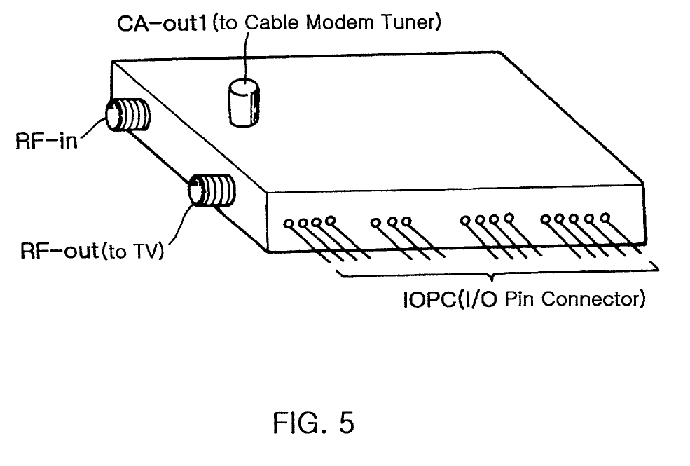

FIG. 5 is a perspective view showing the outer appearance of a channel module apparatus for a cable set-top box in accordance with the present invention. As shown in this drawing, installed in the outer part of the channel module apparatus for the cable set-top box are a radio frequency (RF) input connector RF-in which is provided for connection to a cable to receive a signal via the cable, a first cable connector CA-out1 which transmits the signal received by the RF input connector RF-in to a cable modem tuner of the set-top box, a tuner connection terminal int-out which transfers the signal received by the RF input connector RF-in to an internal tuner of the set-top box, and an RF output connector RF-out which transmits the signal received by the RF input connector RF-in to a television. An input/output (I/O) pin connector IOPC is arranged on a predetermined portion of the outer part of the channel module apparatus for connections to external blocks.

In particular, the channel module apparatus for the cable set-top box is connected to the cable modem tuner via the first cable connector CA-out1 such that the signal received via the cable is distributed and transferred to the cable modem tuner via the first cable connector CA-out1 and a signal transmitted from the cable modem tuner is transferred to the RF input connector RF-in via the first cable connector CA-out1. In order to realize two-way communication via the first cable connector CA-out1, a switching block 21 is provided which has an internal circuitry as will be described later in detail. With this construction, the present channel module apparatus for the cable set-top box is readily connected to the cable modem tuner. Therefore, this channel module apparatus is simple and convenient to manufacture and assemble, thereby increasing the productivity and lowering the production cost.

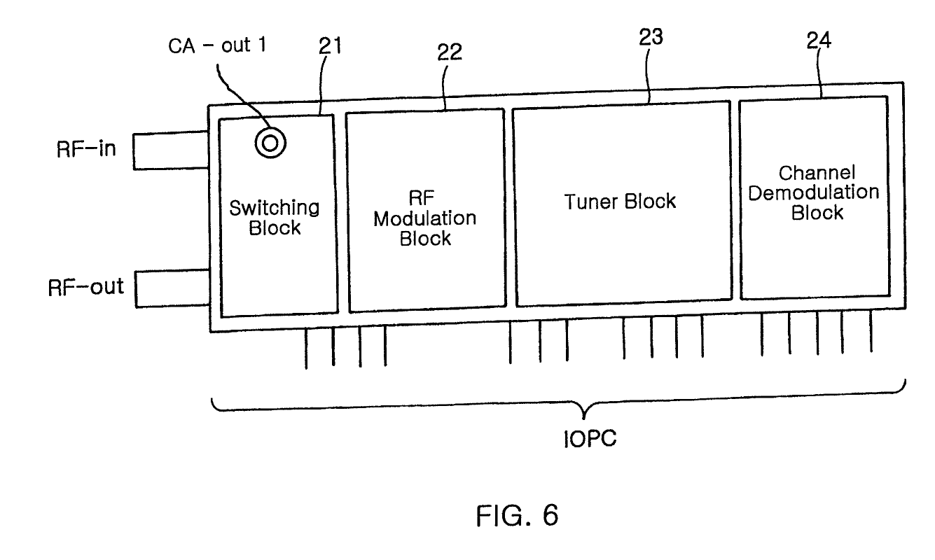

With reference to FIG. 6, there is shown in block form an internal construction of the channel module apparatus of FIG. 5. As shown in this drawing, the channel module apparatus for the cable set-top box comprises a switching block 21 for distributing a signal received via the RF input connector RF-in to the first cable connector CA-out1 and the tuner connection terminal int-out, mixing the received signal with an RF-modulated signal and outputting the resulting signal via the RF output connector RF-out, a tuner block 23 for tuning to an output signal from the switching block 21, a channel demodulation block 24 for demodulating an output signal from the tuner block 23 into audio and video signals, and an RF modulation block 22 for modulating the audio and video signals from the channel demodulation block 24 into a television signal.

The RF modulation block 22 is enabled in response to an operating voltage VT of 30V to receive audio and video signals AUDIO and VIDEO, a clock signal SCL and a data signal SDA and output a modulated television signal.

Notably, in the channel module apparatus for the cable set-top box, the switching block 21, RF modulation block 22, tuner block 23 and channel demodulation block 24 are contained in a single chassis in the form of one package. Hence, the number of components and the number of signal line connections can be reduced to improve a matching characteristic and interference characteristic. Also, the price of a product can be lowered to secure the competitiveness of the product and the composite configuration of components can be realized to increase the productivity.

Alternatively, in the channel module apparatus for the cable set-top box, the RF modulation block 22 for modulating audio and video signals into a television signal and the switching block 21 for distributing a signal received via the RF input connector RF-in to the first cable connector CA-out1 and the tuner connection terminal int-out, mixing the received signal with an RF-modulated signal and outputting the resulting signal via the RF output connector RF-out are contained in a single chassis in the form of one package, so that the number of components and the number of signal line connections can be reduced to improve a matching characteristic and interference characteristic, the price of a product can be lowered to secure the competitiveness of the product and the composite configuration of components can be realized to increase the productivity.

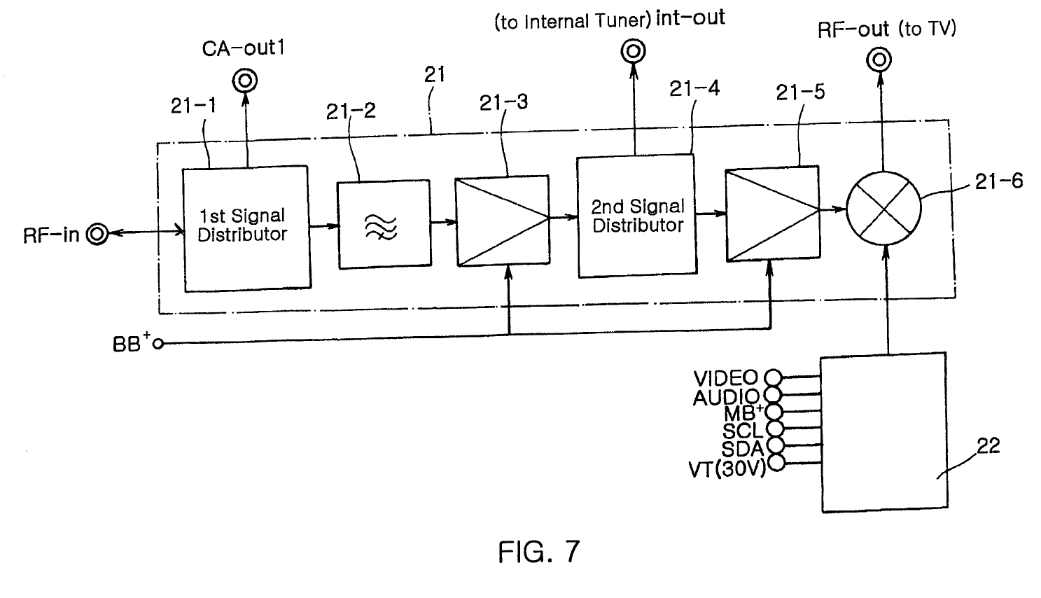

FIG. 7 is a detailed diagram of the switching block 21 in FIG. 6. As shown in this drawing, the switching block 21 includes an RF input connector RF-in provided for connection to a cable, a first signal distributor 21-1 for distributing a signal received via the RF input connector RF-in to two stages, and a first cable connector CA-out1 for transmitting one signal distributed by the first signal distributor 21-1 to an external cable modem tuner and an output signal from the external cable modem tuner to the first signal distributor 21-1, respectively. The switching block 21 further includes a high pass filter (HPF) 21-2 for blocking low-frequency components of the other signal distributed by the first signal distributor 21-1 and passing high-frequency components thereof, a second signal distributor 21-4 for distributing an output signal from the HPF 21-2 to two stages, a tuner connection terminal int-out for transferring one signal distributed by the second signal distributor 21-4 to the tuner block 23, a mixer 21-6 for mixing the other signal distributed by the second signal distributor 21-4 with an output signal from the RF modulation block 22, and an RF output connector RF-out for transmitting an output signal from the mixer 21-6 to a television.

The switching block 21 further includes a first amplifier 21-3 enabled in response to a booster voltage BB+ for amplifying the output signal from the HPF 21-2 and transferring the amplified signal to the second signal distributor 21-4, and a second amplifier 21-5 enabled in response to the booster voltage BB+ for amplifying the other signal distributed by the second signal distributor 21-4 and transferring the amplified signal to the mixer 21-6.

In the switching block 21 with the above-described construction, a signal received via the RF input connector RF-in is distributed to two stages by the first signal distributor 211. One signal distributed by the first signal distributor 21-1 is supplied to the cable modem tuner via the first cable connector CA-out1. Further, the first signal distributor 21-1 receives a signal transmitted from the cable modem tuner via the first cable connector CA-out1 and transfers the received signal to the RF input connector RF-in.

The other signal distributed by the first signal distributor 21-1 is fed to the first amplifier 21-3 through the HPF 21-2. At this time, an output signal from the cable modem tuner is blocked by the HPF 21-2 such that it is not transferred to the first amplifier 21-3. This has the effect of preventing an interference between signals transmitted and received.

The first and second amplifiers 21-3 and 21-5 are enabled in response to the booster voltage BB+, which is supplied from a booster voltage source (not shown) under control of a controller (not shown) of the set-top box.

The first amplifier 21-3 amplifies the output signal from the HPF 21-2 and transfers the amplified signal to the second signal distributor 21-4, which then distributes it to two stages. The first signal distributed by the second signal distributor 21-4 is transferred to the internal tuner 23 via the tuner connection terminal int-out, and the second signal distributed by the second signal distributor 21-4 is amplified by the second amplifier 21-5, mixed with the output signal from the RF modulation block 22 by the mixer 21-6 and then transmitted to the television via the RF output connector RF-out.

Therefore, according to the present invention, a plurality of components, or the switching block 21, RF modulation block 22, tuner block 23 and channel demodulation block 24, conventionally individually made and contained in a plurality of chassis, are contained in a single chassis in the form of one package so as to provide a variety of effects as follows.

As apparent from the above description, the present invention provides a channel module apparatus for a cable set-top box, wherein a switching block, radio frequency modulation block, tuner block and channel demodulation block in the cable set-top box are contained in a single chassis in the form of one package. Therefore, the number of components and the number of signal line connections can be reduced to improve a matching characteristic and interference characteristic, the price of a product can be lowered to secure the competitiveness of the product and the composite configuration of components can be realized to increase the productivity.

Further, the present invention provides a channel module apparatus for a cable set-top box, wherein a switching block, radio frequency modulation block, tuner block and channel demodulation block in the cable set-top box are contained in a single chassis in the form of one package and a first cable connector is provided in the chassis as a connector for a cable modem tuner. Therefore, the cable set-top box can readily be connected to the cable modem tuner, thereby enabling two-way communication.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A channel module apparatus for a cable set-top box, comprising:
a switching block for distributing a signal received via a cable to two or more stages and mixing one of the distributed signals with a radio frequency-modulated signal;
a tuner block for tuning to an output signal from said switching block;
a channel demodulation block for demodulating an output signal from said tuner block into audio and video signals; and
a radio frequency modulation block for modulating the audio and video signals from said channel demodulation block into a television signal.

2. The channel module apparatus as set forth in claim 1, wherein said switching block, radio frequency modulation block, tuner block and channel demodulation block are contained in a single chassis in the form of one package.

3. The channel module apparatus as set forth in claim 1, wherein said switching block includes:
a radio frequency input connector provided for connection to said cable;
a first signal distributor for distributing a signal received via said radio frequency input connector to two stages and transferring a signal transmitted from a cable modem tuner to said radio frequency input connector;
a first cable connector for transmitting one signal distributed by said first signal distributor to said cable modem tuner and an output signal from said cable modem tuner to said first signal distributor, respectively;
a high pass filter for blocking low-frequency components of the other signal distributed by said first signal distributor and passing high-frequency components thereof;
a second signal distributor for distributing an output signal from said high pass filter to two stages;
a tuner connection terminal for transferring one signal distributed by said second signal distributor to said tuner block;
a mixer for mixing the other signal distributed by said second signal distributor with an output signal from said radio frequency modulation block; and
a radio frequency output connector for transmitting an output signal from said mixer to a television.

4. The channel module apparatus as set forth in claim 3, wherein said switching block further includes:
a first amplifier enabled in response to a booster voltage for amplifying the output signal from said high pass filter and transferring the amplified signal to said second signal distributor; and
a second amplifier enabled in response to said booster voltage for amplifying the other signal distributed by said second signal distributor and transferring the amplified signal to said mixer.

5. A channel module apparatus for a cable set-top box, comprising:
a switching block for distributing a signal received via a cable to two or more stages and mixing one of the distributed signals with a radio frequency-modulated signal;
a tuner block for tuning to an output signal from said switching block;
a channel demodulation block for demodulating an output signal from said tuner block into audio and video signals; and
a radio frequency modulation block for modulating the audio and video signals from said channel demodulation block into a television signal;
said switching block, radio frequency modulation block, tuner block and channel demodulation block being contained in a single chassis in the form of one package.

6. A channel module apparatus for a cable set-top box, comprising:
a radio frequency modulation block for modulating audio and video signals into a television signal; and
a switching block for distributing a signal received via a radio frequency input connector to a first cable connector and a tuner connection terminal, mixing the received signal with an radio frequency-modulated signal and outputting the resulting signal via a radio frequency output connector;
said radio frequency modulation block and switching block being contained in a single chassis in the form of one package.

7. The channel module apparatus as set forth in claim 6, wherein said switching block includes:
said radio frequency input connector provided for connection to a cable;
a first signal distributor for distributing the signal received via said radio frequency input connector to two stages and transferring a signal transmitted from a cable modem tuner to said radio frequency input connector;
said first cable connector adapted for transmitting one signal distributed by said first signal distributor to said cable modem tuner and an output signal from said cable modem tuner to said first signal distributor, respectively;
a high pass filter for blocking low-frequency components of the other signal distributed by said first signal distributor and passing high-frequency components thereof;
a second signal distributor for distributing an output signal from said high pass filter to two stages;
said tuner connection terminal adapted for transferring one signal distributed by said second signal distributor to an internal tuner block;
a mixer for mixing the other signal distributed by said second signal distributor with an output signal from said radio frequency modulation block; and
said radio frequency output connector adapted for transmitting an output signal from said mixer to a television.

8. The channel module apparatus as set forth in claim 7, wherein said switching block further includes:
a first amplifier enabled in response to a booster voltage for amplifying the output signal from said high pass filter and transferring the amplified signal to said second signal distributor; and
a second amplifier enabled in response to said booster voltage for amplifying the other signal distributed by said second signal distributor and transferring the amplified signal to said mixer.
